(19) United States
(12) Patent Application Publication
(10) Pub. No.: US 2022/0179651 A1
(43) Pub. Date: Jun. 9, 2022

(54) SMART CONTRACT CLIENT PROGRAM GENERATION METHOD, SYSTEM AND DEVICE, AND MEDIUM

(71) Applicant: HANGZHOU QULIAN TECHNOLOGY CO., LTD., Hangzhou (CN)

(72) Inventors: Weiwei QIU, Hangzhou (CN); Wei LI, Hangzhou (CN); Liang CAI, Hangzhou (CN); Shuai ZHANG, Hangzhou (CN); Dingwen ZHANG, Hangzhou (CN)

(21) Appl. No.: 17/676,840

(22) Filed: Feb. 22, 2022

Related U.S. Application Data
(63) Continuation of application No. PCT/CN2020/115407, filed on Sep. 15, 2020.

(30) Foreign Application Priority Data
Sep. 16, 2019 (CN) 201910870035.3

(51) Int. Cl. G06F 8/75; G06F 8/41; G06F 9/54

(52) U.S. Cl. CPC G06F 8/75; G06F 8/42; G06F 9/547; G06F 8/437; G06F 8/433

(57) ABSTRACT

A smart contract client program generation method, system and device, and a medium are provided. The method includes: analyzing an interface of a smart contract according to an ABI or a source code of the smart contract; generating, according to an interface analysis result, entity classes corresponding to an incoming parameter and a return parameter of the interface of the smart contract; generating, according to the interface analysis result, a calling method corresponding to the interface of the smart contract; and generating, according to a matched calling layer framework design mode, the entity classes and the calling method, a calling layer program of a smart contract client.

### CROSS-REFERENCE TO RELATED APPLICATIONS

This application is a continuation of international application No. PCT/CN2020/115407 filed on Sep. 15, 2020, which claims all benefits accruing from China Patent Application No. 201910870035.3, filed on Sep. 16, 2019, titled “METHOD FOR AUTOMATICALLY GENERATING JAVA CLIENT PROGRAM OF SOLIDITY SMART CONTRACT” in the China National Intellectual Property Administration, both of which are hereby incorporated by reference.

### TECHNICAL FIELD

The present disclosure generally relates to the technical field of a smart contract, and in particular, to a smart contract client program generation method, a system, a device, and a medium.

### BACKGROUND

A smart contract is a computer program which is executable in a blockchain. After the smart contract is deployed on the blockchain, the smart contract can be called by a client program to obtain a service of a corresponding interface defined on the smart contract. Java is an object-oriented programming language, is one of the mainstream backstage development languages. A Java client program is a primary choice for many developers to call a smart contract interface. Generally speaking, after writing a smart contract, developers need to write a client program to call the smart contract accordingly. The process of developing a smart contract client program is cumbersome and inefficient.

### SUMMARY

According to various embodiments of the present disclosure, a method for automatically generating a Java client program of a Solidity smart contract is provided. The method includes the following steps: (1) analyzing an interface of a smart contract according to an Application Binary Interface (ABI) or a source code of the smart contract; (2) automatically generating, according to an interface analysis result, entity classes corresponding to an incoming parameter and a return parameter of the interface of the smart contract; (3) automatically generating, according to the interface analysis result, a calling method corresponding to the interface of the smart contract; and (4) generating, according to a matched calling layer framework design mode, a calling layer program of a smart contract client.

In an embodiment of the present disclosure, the analyzing the interface of the smart contract in step (1) includes the following steps: when the ABI of the smart contract is provided, establishing an ABI analyzing object corresponding to the ABI, and converting an ABI text into the ABI analyzing object through a JavaScript Object Notation (JSON) conversion, so as to obtain information of all interfaces of the smart contract; and when the source code of the smart contract is provided, syntactically analyzing a source code text of the smart contract to establish a syntax tree, so as to obtain the information of all interfaces of the smart contract.

In an embodiment of the present disclosure, the automatically generating entity classes corresponding to the incoming parameter and the return parameter of the interface of the smart contract in step (2) includes the following steps: determining a name of a package where the entity classes are located according to a contract name, and determining an entity class name according to an interface name and a serial number of an interface definition; converting types of interface parameters into field types of the entity classes; determining names of fields of the entity classes according to naming information of the interface parameters; and generating a constructor, a Get method, a Set method, a To String method, an Equals method and a Hash Code method of the entity classes according to a Plain Ordinary Java Object (POJO) specification.

In an embodiment of the present disclosure, the automatically generating the calling method corresponding to the interface of the smart contract in step (3) includes the following steps: defining an interface of the call layer, an interface name of the call layer is determined by a contract name, a method in the interface of the call layer corresponds to the interface exposed in the smart contract, a method name is determined by the interface name and a serial number of an interface definition, and an incoming parameter and a return parameter of the method are the corresponding entity classes; and implementing an implementation class corresponding to the interface of the call layer, an implementation class name is determined by the contract name, and an implementation of the method in the implementation class includes: converting the entity classes passed in as method parameters into corresponding smart contract parameters; specifying the corresponding interface of the smart contract and passing in the smart contract parameters, and calling the corresponding interface through an Application Programming Interface (API) provided by the smart contract to obtain the return parameter of the smart contract; and converting the return parameter of the smart contract into the corresponding entity class, which is returned by the method.

In an embodiment of the present disclosure, the generating the calling layer program of the smart contract client in step (4) includes the following steps: defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and (2) encapsulating an API provided by the smart contract.

According to various embodiments of the present disclosure, a smart contract client program generation method is further provided. The generation method includes the following steps: analyzing an interface of a smart contract according to an ABI or a source code of the smart contract; generating, according to an interface analysis result, entity classes corresponding to an incoming parameter and a return parameter of the interface of the smart contract; generating, according to the interface analysis result, a calling method corresponding to the interface of the smart contract; and generating, according to a matched calling layer framework design mode, the entity classes and the calling method, a calling layer program of a smart contract client.

In an embodiment of the present disclosure, the analyzing the interface of the smart contract includes the following steps: when the ABI of the smart contract is provided, converting an ABI text into an ABI analyzing object through a JSON conversion, so as to obtain information of all interfaces of the smart contract; and when the source code of the smart contract is provided, syntactically analyzing a source code text of the smart contract to establish a syntax tree, so as to obtain the information of all interfaces of the smart contract.

In an embodiment of the present disclosure, the generating, according to the interface analysis result, the entity classes corresponding to the incoming parameter and the return parameter of the interface of the smart contract comprises the following steps: determining a name of a package where the entity classes are located according to a contract name, and determining an entity class name according to an interface name and a serial number of an interface definition; converting types of the incoming parameter and the return parameter of the interface into field types of the entity classes; determining names of fields of the entity classes according to naming information of the incoming parameter and the return parameter of the interface; and generating a constructor, a Get method, a Set method, a To String method, an Equals method and a Hash Code method of the entity classes according to a POJO specification.

In an embodiment of the present disclosure, the generating, according to the interface analysis result, the calling method corresponding to the interface of the smart contract comprises the following steps: defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes; and implementing an implementation class corresponding to the interface of the call layer. An implementation class name is determined according to the contract name, and an method in the implementation class comprises the following steps: converting the entity classes passed in as the incoming parameter of the calling method into corresponding smart contract parameters; specifying the corresponding interface of the smart contract and passing in the smart contract parameters, and calling the corresponding interface through an API provided by the smart contract to obtain the return parameter of the smart contract; and converting the return parameter of the smart contract into the corresponding entity class, which is returned by the calling method.

In an embodiment of the present disclosure, the generating, according to the matched calling layer framework design mode, the entity classes and the calling method, the calling layer program of the smart contract client comprises the following steps: defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and encapsulating an API provided by the smart contract.

According to various embodiments of the present disclosure, a smart contract client program generation system is further provided. The generation system includes: an interface analyzing module configured for analyzing an interface of a smart contract according to an ABI or a source code of the smart contract; an entity class generating module configured for generating, according to an interface analysis result, entity classes corresponding to an incoming parameter and a return parameter of the interface of the smart contract; a calling method generating module configured for generating, according to the interface analysis result, a calling method corresponding to the interface of the smart contract; and a program generating module configured for generating, according to a matched calling layer framework design mode, the entity classes and the calling method, a calling layer program of a smart contract client.

According to various embodiments of the present disclosure, a smart contract client program generation device is further provided. The generation device includes a memory and a processor. The memory stores a computer program, which is executed by the processor to implement the steps of the smart contract client program generation method above.

According to various embodiments of the present disclosure, a readable storage medium is further provided. The readable storage medium has stored a computer program, which is executed by a processor to implement the steps of the smart contract client program generation method above.

### BRIEF DESCRIPTION OF THE DRAWINGS

To describe and illustrate embodiments and/or examples of the present disclosure made public here better, reference may be made to one or more of the figures. The additional details or examples used to describe the figures should not be construed as limiting the scope of any of the present disclosure, the embodiments and/or examples currently described, and the best model of the present disclosure as currently understood.

FIG. 1 is a flowchart diagram of a method for automatically generating a Java client program of a Solidity smart contract in an embodiment of the present disclosure.

FIG. 2 is a UML diagram based on an automatically generated Java client program of the Solidity smart contract in an embodiment of the present disclosure.

FIG. 3 is a flowchart diagram of a smart contract client program generation method in an embodiment of the present disclosure.

FIG. 4 is a schematic diagram of a smart contract client program generation system in an embodiment of the present disclosure.

FIG. 5 is an internal schematic diagram of a smart contract client program generation device in an embodiment of the present disclosure.

### DETAILED DESCRIPTION OF THE EMBODIMENTS

In order to facilitate the understanding of the present disclosure and make the above purposes, features and advantages of the present disclosure more obvious and understandable, the following is a detailed explanation of the specific implementation of the present disclosure combined with the attached drawings. Many details are explained in the description below in order to fully understand the present disclosure, and a better embodiment to implement the present disclosure is given in the attached drawings. However, the present disclosure can be implemented in many different forms and is not limited to the implementation described herein. Rather, the purpose of providing these embodiments is to provide a more thorough understanding of the present disclosure. The present disclosure can be performed in many other ways other than those described herein, and similar improvements can be made by a person skilled in the art without violating the meaning of the present disclosure, so the present disclosure is not limited by specific embodiments disclosed below.

Furthermore, the terms “first” and “second” are used for a descriptive purpose only and are not to be understood to indicate or imply relative importance or to indicate implicitly a number of indicated technical features. Thus, features that are qualified as “first” or “second” may include, explicitly or implicitly, at least one of these features. In the description of the present disclosure, “multiple” means at least two, e.g., two, three, etc., unless otherwise expressly and specifically qualified. In the description of the present disclosure, “several” means at least one, e.g. one, two, etc., unless otherwise expressly and specifically qualified.

Unless otherwise defined, all technical and scientific terms used herein have the same meaning as those normally understood by a person skilled in the art of the present disclosure. The terms used herein are intended only to describe the specific embodiments and are not intended to limit the present disclosure. The term “and/or” used herein includes any and all combinations of one or more related listed items.

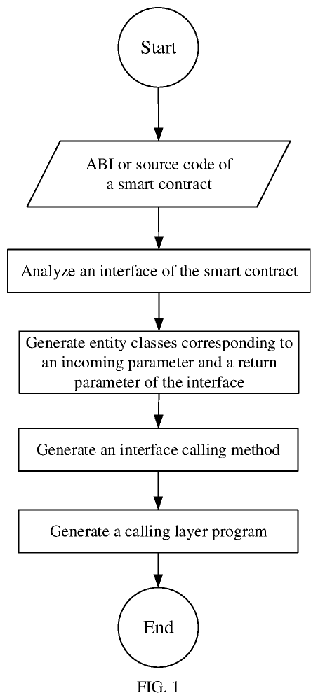

As shown in FIG. 1, a method for automatically generating a Java client program of a Solidity smart contract includes the following steps S1-S4: S1: an interface of a smart contract is analyzed according to an ABI or a source code of the smart contract.

When the ABI of the smart contract is provided, an ABI analyzing object is established corresponding to the ABI, and an ABI text is converted into the ABI analyzing object through a JSON conversion, resulting in that information of all interfaces of the smart contract is obtained.

When the source code of the smart contract is provided, a source code text of the smart contract is syntactically analyzed to establish a syntax tree, resulting in that the information of all interfaces of the smart contract is obtained.

When the information of interfaces is extracted based on the syntax tree, only a public function needs to be extracted.

S2: entity classes corresponding to an incoming parameter and a return parameter of the interface of the smart contract are automatically generating according to an interface analysis result.

A name of a package where the entity classes are located is determined by a contract name, and an entity class name is determined by an interface name and a serial number of an interface definition.

Field types of the entity classes are converted according to types of the incoming parameter and the return parameter of the interface. When applied to the Solidity smart contract and the Java client program, Solidity is a computer high-level language for writing a smart contract that runs on the Ethereum virtual machine (EVM). Since a basic unit of data in the Solidity smart contract has 256 bytes, in order to represent fully in the Java client, the field types of Java entity classes have all string types corresponding to themselves. Array types in the Solidity are represented as string array types in Java entity classes.

Names of fields of the entity classes are determined by naming information of the interface parameters.

A constructor, a Get method, a Set method, a To String method, an Equals method and a Hash Code method of the entity classes are generated according to a POJO (Plain Ordinary Java Object) specification.

S3: a calling method corresponding to the interface of the smart contract is automatically generated according to the interface analysis result.

Specifically, (1) an interface of the call layer is defined. An interface name of the call layer is determined by a contract name, a method in the interface of the call layer corresponds to the interface exposed in the smart contract, a method name is determined by the interface name and a serial number of an interface definition, and an incoming parameter and a return parameter of the method are corresponding entity classes.

(2) An implementation class corresponding to the interface of the call layer is implemented. An implementation class name is determined by the contract name, and an implementation of the method in the implementation class mainly includes: Firstly, the entity classes passed in as method parameters are converted into corresponding smart contract parameters. Secondly, the corresponding interface of the smart contract is specified and the smart contract parameters are passed in the corresponding interface, and the corresponding interface is called through an API provided by the smart contract to obtain the return parameter of the smart contract. Thirdly, the return parameter of the smart contract is converted into the corresponding entity class, which is returned by the method.

S4: a calling layer program of a smart contract client is generated according to a matched calling layer framework design mode.

Specifically, (1) conversion for the entity classes into tool classes of parameters of the smart contract is defined and implemented. One-to-one conversion is directly carried out for basic types in the smart contract. For an array type and a variable length string type in the smart contract, splitting and converting a length of each fragment after splitting. When converting the Java entity classes to the incoming parameter of the Solidity smart contract, essentially the string is converted to a corresponding data type in the Solidity, and the data eventually passed into the API (Application Programming Interface) is ultimately sent as a string, according to a call interface provided by the API of the smart contract. For a Java entity class with multiple fields corresponding to the same type of Solidity, the number of parameters of the Solidity smart contract can be reduced by consolidating the fields into an array of the type which is passed in uniformly and avoiding exceeding a stack limit of the EVM. At this moment, when an array of the type exists in the Java entity class, due to the difference in the length of the arrays occupied, it is necessary to record the length of the arrays occupied by each field in an incoming parameter array, which is recorded in an additional positive integer array. Similarly, when converting the return parameter of the Solidity smart contract into a Java entity class, if the array of the type is returned, it is spliced into strings in the Java entity class accordingly according to the above splitting rules, ensuring that elements of the array are spliced in accordance with a length definition at the time of splitting.

(2) An API provided by the smart contract is encapsulated, which can provide support for exception catching, synchronous and asynchronous invocation and other features. The implementation of the encapsulation and the support for related features depend on a specific blockchain protocol and the API provided, but should satisfy a basic function of calling the smart contract interface.

The Java client program of the solidity smart contract is automatically generated according to the method in the present disclosure. By following corresponding conventions of a program framework of the calling layer, the developer passes in the Java entity class as an incoming parameter of the interface of the smart contract and obtains a return result of the Java entity class. The developer only needs to care about the calling layer of the smart contract, eliminating the steps of interface analysis and parameter conversion of the smart contract, greatly reducing a development workload of the client program.

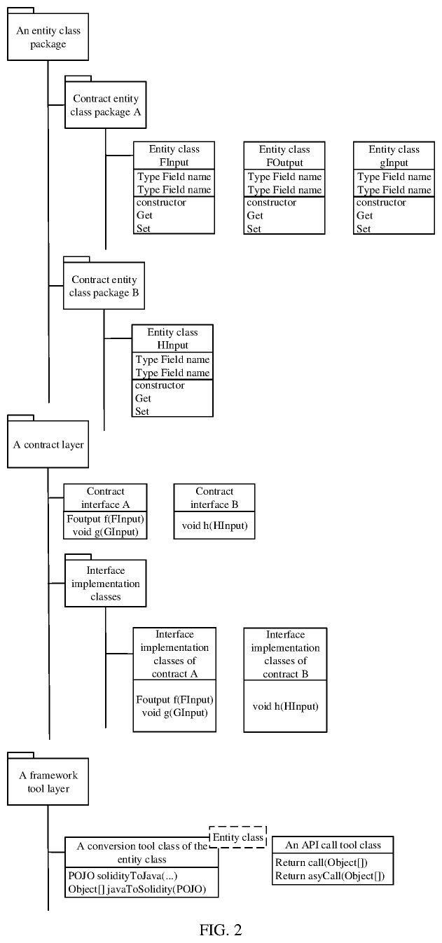

The Java client program of the solidity smart contract is automatically generated according to the method in the present disclosure. The finally generated client program is shown in the form of a UML diagram in FIG. 2. A specific Java structure contained in the client program is as follows: (1) an entity class package: this package is configured to manage the entity classes in all projects, especially an entity class of the incoming parameter and an entity class of the return parameter related to the calling of the smart contract.

(2) A contract entity class package: this package is configured to manage an entity class of the incoming parameter and an entity class of the return parameter of all interfaces in a smart contract, a name of the contract entity class package is determined by the contract name.

(3) An entity class of the incoming parameter or an entity class of the return parameter: these entity classes correspond to an incoming parameter of an interface in a contract, and the field types of the entity classes are a string or an array of strings, and names of fields of are determined by names of the parameters, and contain a default constructor, a Get method, a Set method, a To String method, an Equals method, a Hash Code method of POJO class, and an entity class name is determined by an interface name and a serial number of an interface.

(4) A contract layer package: this package is configured to manage the calling interfaces and interface implementation classes of all smart contracts.

(5) A contract interface: this interface corresponds to all interfaces of a contract, i.e., a method corresponds to a public function in the smart contract. A method name is determined by the interface name and the serial number of the interface, an incoming parameter of the method is the entity class of the incoming parameter corresponding to the method, and a return parameter of the method is the entity class of the return parameter corresponding to the method. For interfaces without an incoming parameter, the incoming parameter of the method is null. For interfaces without a return parameter, the return parameter of the method is void.

(6) An interface entity class package: this package is configured to manage the interface implementation classes of all contract.

An implementation class of a contract interface: this class corresponds to the implementation of a contract interface. The method declaration is consistent with a method declaration in the interface. The method implementation logic mainly includes: Firstly, the entity class passed in as the incoming parameter of the method is converted into the corresponding smart contract parameters. Secondly, the corresponding interface of the smart contract is specified and the smart contract parameters are passed in, and the corresponding interface is called through an API provided by the smart contract to obtain the return parameter of the smart contract. Thirdly, the return parameter of the smart contract is converted into the corresponding entity class, which is returned by the method.

(7) A framework tool layer: this package is configured to manage related interface analysis, parameter conversion and other tool classes called by all contract.

(8) A conversion tool class of the entity class: the tool class is configured to convert the entity class of the incoming parameter or the entity class of the return parameter and smart contract parameters to each other, and conversion rules are as described above.

(9) An API call tool class: an underlying method tool class is configured to call the smart contract interface, whose implementation depends on the specific blockchain protocol and the API provided, but should meet the basic function of calling the smart contract interface.

The present disclosure has the following advantages: the method of the present disclosure provides a general method for an interface analysis and a parameter transformation of the smart contract, and a matched calling layer framework design mode, automatically generating a calling layer program of the smart contract client. The caller can call the interface of the smart contract easily by following the framework of the call layer of the present disclosure, without caring about the interface analysis and the parameter conversion, which simplifies a development process of the traditional smart contract and improves a development efficiency of the smart contract.

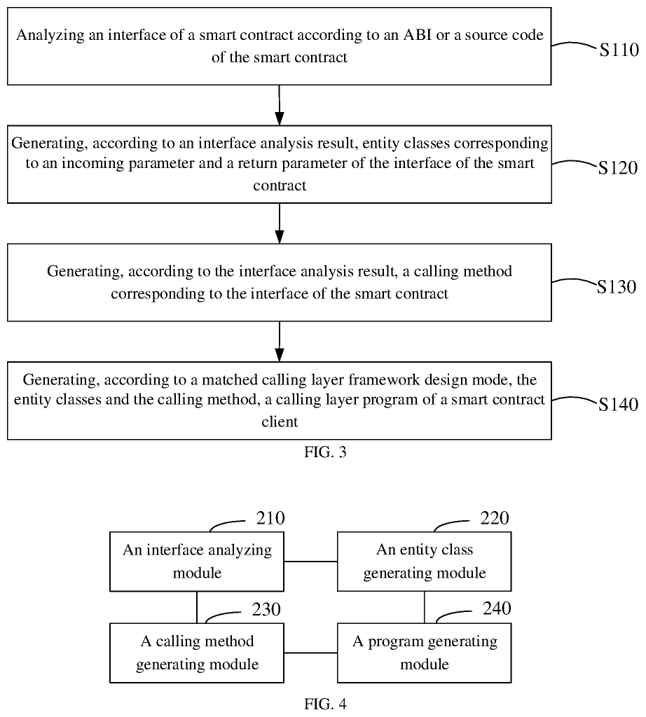

Furthermore, the Solidity is a high-level computer language for writing a smart contract. When other programming languages are used, a smart contract can also be written. The solution in the present disclosure is also applicable. Therefore, for a smart contract, as shown in FIG. 3, the following schemes can be adopted to realize a generation of a smart contract client program: at step 110, analyzing an interface of a smart contract according to an ABI or a source code of the smart contract; at step 120, generating, according to an interface analysis result, entity classes corresponding to an incoming parameter and a return parameter of the interface of the smart contract; at step 130, generating, according to the interface analysis result, a calling method corresponding to the interface of the smart contract; and at step 140, generating, according to a matched calling layer framework design mode, the entity classes and the calling method, a calling layer program of a smart contract client.

In an embodiment, the analyzing the interface of the smart contract includes the following steps: when the ABI of the smart contract is provided, converting an ABI text into an ABI analyzing object through a JSON conversion, so as to obtain information of all interfaces of the smart contract; and when the source code of the smart contract is provided, syntactically analyzing a source code text of the smart contract to establish a syntax tree, so as to obtain the information of all interfaces of the smart contract.

In an embodiment, the generating, according to the interface analysis result, the entity classes corresponding to the incoming parameter and the return parameter of the interface of the smart contract comprises the following steps: determining a name of a package where the entity classes are located according to a contract name, and determining an entity class name according to an interface name and a serial number of an interface definition; converting types of the incoming parameter and the return parameter of the interface into field types of the entity classes; determining names of fields of the entity classes according to naming information of the incoming parameter and the return parameter of the interface; generating a constructor, a Get method, a Set method, a To String method, an Equals method and a Hash Code method of the entity classes according to a POJO specification.

In an embodiment, the generating, according to the interface analysis result, the calling method corresponding to the interface of the smart contract comprises the following steps: defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes; and implementing an implementation class corresponding to the interface of the call layer, wherein an implementation class name is determined according to the contract name, and an method in the implementation class comprises the following steps: converting the entity classes passed in as the incoming parameter of the calling method into corresponding smart contract parameters; specifying the corresponding interface of the smart contract and passing in the smart contract parameters, and calling the corresponding interface through an API provided by the smart contract to obtain the return parameter of the smart contract; and converting the return parameter of the smart contract into the corresponding entity class, which is returned by the calling method.

In an embodiment, the generating, according to the matched calling layer framework design mode, the entity classes and the calling method, the calling layer program of the smart contract client comprises the following steps: defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and encapsulating an API provided by the smart contract.

In an embodiment, as shown in FIG. 4, a smart contract client program generation system is provided. The system includes an interface analyzing module 210, an entity class generating module 220, a calling method generating module 230, and a program generating module 240. The interface analyzing module 210 is configured for analyzing an interface of a smart contract according to an ABI or a source code of the smart contract. The entity class generating module 220 is configured for generating, according to an interface analysis result, entity classes corresponding to an incoming parameter and a return parameter of the interface of the smart contract. The calling method generating module 230 is configured for generating, according to the interface analysis result, a calling method corresponding to the interface of the smart contract. The program generating module 240 is configured for generating, according to a matched calling layer framework design mode, the entity classes and the calling method, a calling layer program of a smart contract client.

In an embodiment, the interface analyzing module 210 is further configured for converting an ABI text into an ABI analyzing object through a JSON conversion, so as to obtain information of all interfaces of the smart contract when the ABI of the smart contract is provided, and syntactically analyzing a source code text of the smart contract to establish a syntax tree, so as to obtain the information of all interfaces of the smart contract when the source code of the smart contract is provided.

In an embodiment, the entity class generating module 220 is further configured for determining a name of a package where the entity classes are located according to a contract name, and determining an entity class name according to an interface name and a serial number of an interface definition; converting types of the incoming parameter and the return parameter of the interface into field types of the entity classes; determining names of fields of the entity classes according to naming information of the incoming parameter and the return parameter of the interface; and generating a constructor, a Get method, a Set method, a To String method, an Equals method and a Hash Code method of the entity classes according to a POJO specification.

In an embodiment, the calling method generating module 230 is further configured for defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes.

The calling method generating module 230 is further configured for implementing an implementation class corresponding to the interface of the call layer. An implementation class name is determined according to the contract name, and an method in the implementation class comprises the following steps: converting the entity classes passed in as the incoming parameter of the calling method into corresponding smart contract parameters; specifying the corresponding interface of the smart contract and passing in the smart contract parameters, and calling the corresponding interface through an API provided by the smart contract to obtain the return parameter of the smart contract; and converting the return parameter of the smart contract into the corresponding entity class, which is returned by the calling method.

In an embodiment, the program generating module 240 is further configured for defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and encapsulating an API provided by the smart contract.

For specific restrictions on the smart contract client program generation system, please refer to the above restrictions on the smart contract client program generation method, which will not be described here. All the modules in the smart contract client program generation system can be fully or partially realized by software, hardware and a combination thereof. The above modules can be embedded in or independent of a processor in a computer device in the form of hardware, or stored in a memory in the computer device in the form of software, so that the processor can call to perform operations corresponding to the above modules.

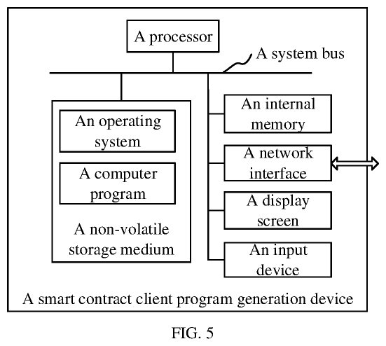

In an embodiment, a smart contract client program generation device is provided, which may be a terminal, and its internal structure diagram may be shown in FIG. 5. The smart contract client program generation device includes a processor, a memory, a network interface, a display screen and an input device connected through a system bus. The processor of the smart contract client program generation device is configured to provide computing and control capabilities. The memory of the smart contract client program generation device includes a non-volatile storage medium and an internal memory. The non-volatile storage medium stores an operating system and a computer program. The internal memory provides an environment for the operation of the operating system and the computer program in the non-volatile storage medium. The network interface of the smart contract client program generation device is configured to communicate with an external terminal over a network connection. The computer program is executed by the processor to implement a smart contract client program generation method. The display screen of the smart contract client program generation device can be a liquid crystal display screen or an electronic ink display screen. The input device of the smart contract client program generation device can be a touch layer covered on the display screen, or a key, a track ball or a track pad set on the shell of the smart contract client program generation device, or an external keyboard, a track pad or a mouse, etc.

A person skilled in the art may understand that, a structure shown in FIG. 5 is only a part related to the scheme in the present disclosure, the structure block diagram does not limit the computer device on which the scheme in the present disclosure is applied, a specific computer device may include more or less than shown in the figure, or combination of some parts, or different decorations with parts.

In an embodiment, a smart contract client program generation device is provided. The device includes a memory and a processor. The memory stores a computer program, which is executed by the processor to implement the steps of the smart contract client program generation method above.

In an embodiment, a readable storage medium is provided. The readable storage medium has stored a computer program, which is executed by a processor to implement the steps of the smart contract client program generation method above.

The person skilled in the art can understand that all or part of the process in the method of the above embodiment can be accomplished by instructing the associated hardware by a computer program, which may be stored in a non-volatile computer readable storage medium. The computer program may include the process of each method in the above embodiments when executed. Any reference to a memory, a database or other medium used in each embodiment provided by the present disclosure may include at least one of a non-volatile memory and a volatile memory. The non-volatile memory may include a Read-Only Memory (ROM), a programmable ROM (PROM), an electrically programmable ROM (EPROM), an electrically erasable programmable ROM (EEPROM), or a flash memory. The volatile memory may include a Random-Access Memory (RAM) or an external cache memory. As an illustration rather than a limitation, the RAM is available in a variety of forms, such as a Static Random Access Memory (SRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a Synchronous Link Dynamic Random Access Memory (SLDRAM), a Rambus Direct Random Access Memory (RDRAM), a Direct Rambus Dynamic Random Access Memory (DRDRAM), a Rambus Dynamic Random Access Memory (RDRAM), etc.

The technical features of the above-described embodiments may be combined in any combination. For the sake of brevity of description, not all possible combinations of the technical features in the above embodiments are described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a plurality of variations and modifications may be made by those skilled in the art without departing from the spirit and scope of the disclosure. Therefore, the scope of the disclosure should be determined by the appended claims.

What is claimed is:

1. A method for automatically generating a Java client program of a Solidity smart contract, comprising the following steps:
(1) analyzing an interface of a smart contract according to an Application Binary Interface (ABI) or a source code of the smart contract;
(2) automatically generating, according to an interface analysis result, entity classes corresponding to an incoming parameter and a return parameter of the interface of the smart contract;
(3) automatically generating, according to the interface analysis result, a calling method corresponding to the interface of the smart contract; and
(4) generating, according to a matched calling layer framework design mode, a calling layer program of a smart contract client.

2. The method of claim 1, wherein the analyzing the interface of the smart contract in step (1) comprises:
when the ABI of the smart contract is provided, establishing an ABI analyzing object corresponding to the ABI, and converting an ABI text into the ABI analyzing object through a JavaScript Object Notation (JSON) conversion, so as to obtain information of all interfaces of the smart contract; and
when the source code of the smart contract is provided, syntactically analyzing a source code text of the smart contract to establish a syntax tree, so as to obtain the information of all interfaces of the smart contract.

3. The method of claim 1, wherein the automatically generating the entity classes corresponding to the incoming parameter and the return parameter of the interface of the smart contract in step (2) comprises:
determining a name of a package where the entity classes are located according to a contract name, and determining an entity class name according to an interface name and a serial number of an interface definition;
converting types of interface parameters into field types of the entity classes;
determining names of fields of the entity classes according to naming information of the interface parameters; and
generating a constructor, a Get method, a Set method, a To String method, an Equals method and a Hash Code method of the entity classes according to a Plain Ordinary Java Object (POJO) specification.

4. The method of claim 1, wherein the automatically generating the calling method corresponding to the interface of the smart contract in step (3) comprises:
defining an interface of the call layer, wherein an interface name of the call layer is determined by a contract name, a method in the interface of the call layer corresponds to the interface exposed in the smart contract, a method name is determined by the interface name and a serial number of an interface definition, and an incoming parameter and a return parameter of the method are the corresponding entity classes; and
implementing an implementation class corresponding to the interface of the call layer, wherein an implementation class name is determined by the contract name, and an implementation of the method in the implementation class comprises:
converting into corresponding smart contract parameters;
specifying the corresponding interface of the smart contract and passing in the smart contract parameters, and calling the corresponding interface through an Application Programming Interface (API) provided by the smart contract to obtain the return parameter of the smart contract; and
converting the return parameter of the smart contract into the corresponding entity class, which is returned by the method.

5. The method of claim 1, wherein the generating the calling layer program of the smart contract client in step (4) comprises:
defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and
encapsulating an API provided by the smart contract.

6. A smart contract client program generation method, comprising the following steps:
analyzing an interface of a smart contract according to an ABI or a source code of the smart contract;
generating, according to an interface analysis result, entity classes corresponding to an incoming parameter and a return parameter of the interface of the smart contract;
generating, according to the interface analysis result, a calling method corresponding to the interface of the smart contract; and
generating, according to a matched calling layer framework design mode, the entity classes and the calling method, a calling layer program of a smart contract client.

7. The method of claim 6, wherein the analyzing the interface of the smart contract comprises the following steps:
when the ABI of the smart contract is provided, converting an ABI text into an ABI analyzing object through a JSON conversion, so as to obtain information of all interfaces of the smart contract; and
when the source code of the smart contract is provided, syntactically analyzing a source code text of the smart contract to establish a syntax tree, so as to obtain the information of all interfaces of the smart contract.

8. The method of claim 6, wherein the generating, according to the interface analysis result, the entity classes corresponding to the incoming parameter and the return parameter of the interface of the smart contract comprises the following steps:
determining a name of a package where the entity classes are located according to a contract name, and determining an entity class name according to an interface name and a serial number of an interface definition;
converting types of the incoming parameter and the return parameter of the interface into field types of the entity classes;
determining names of fields of the entity classes according to naming information of the incoming parameter and the return parameter of the interface; and
generating a constructor, a Get method, a Set method, a To String method, an Equals method and a Hash Code method of the entity classes according to a POJO specification.

9. The method of claim 6, wherein the generating, according to the interface analysis result, the calling method corresponding to the interface of the smart contract comprises the following steps:
defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes; and
implementing an implementation class corresponding to the interface of the call layer, wherein an implementation class name is determined according to the contract name, and an method in the implementation class comprises the following steps:
converting the entity classes passed in as the incoming parameter of the calling method into corresponding smart contract parameters;
specifying the corresponding interface of the smart contract and passing in the smart contract parameters, and calling the corresponding interface through an API provided by the smart contract to obtain the return parameter of the smart contract; and
converting the return parameter of the smart contract into the corresponding entity class, which is returned by the calling method.

10. The method of claim 6, wherein the generating, according to the matched calling layer framework design mode, the entity classes and the calling method, the calling layer program of the smart contract client comprises the following steps:
defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and
encapsulating an API provided by the smart contract.

11. A smart contract client program generation system, comprising:
means for analyzing an interface of a smart contract according to an ABI or a source code of the smart contract;
means for generating, according to an interface analysis result, entity classes corresponding to an incoming parameter and a return parameter of the interface of the smart contract;
means for generating, according to the interface analysis result, a calling method corresponding to the interface of the smart contract; and
means for generating, according to a matched calling layer framework design mode, the entity classes and the calling method, a calling layer program of a smart contract client.

12. A smart contract client program generation device, comprising a processor and a memory that stores a computer program, the computer program being executed by the processor to implement the steps of the smart contract client program generation method of claim 6.

13. A non-transitory computer readable storage medium having stored a computer program, wherein the computer program is executed by a processor to implement the steps of the smart contract client program generation method of claim 6.

14. The device of claim 12, wherein the analyzing the interface of the smart contract comprises the following steps:
when the ABI of the smart contract is provided, converting an ABI text into an ABI analyzing object through a JSON conversion, so as to obtain information of all interfaces of the smart contract; and
when the source code of the smart contract is provided, syntactically analyzing a source code text of the smart contract to establish a syntax tree, so as to obtain the information of all interfaces of the smart contract.

15. The device of claim 12, wherein the generating, according to the interface analysis result, the entity classes corresponding to the incoming parameter and the return parameter of the interface of the smart contract comprises the following steps:
determining a name of a package where the entity classes are located according to a contract name, and determining an entity class name according to an interface name and a serial number of an interface definition;
converting types of the incoming parameter and the return parameter of the interface into field types of the entity classes;
determining names of fields of the entity classes according to naming information of the incoming parameter and the return parameter of the interface; and
generating a constructor, a Get method, a Set method, a To String method, an Equals method and a Hash Code method of the entity classes according to a POJO specification.

16. The device of claim 12, wherein the generating, according to the interface analysis result, the calling method corresponding to the interface of the smart contract comprises the following steps:
defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes; and
implementing an implementation class corresponding to the interface of the call layer, wherein an implementation class name is determined according to the contract name, and an method in the implementation class comprises the following steps:
converting the entity classes passed in as the incoming parameter of the calling method into corresponding smart contract parameters;
specifying the corresponding interface of the smart contract and passing in the smart contract parameters, and calling the corresponding interface through an API provided by the smart contract to obtain the return parameter of the smart contract; and
converting the return parameter of the smart contract into the corresponding entity class, which is returned by the calling method.

17. The device of claim 12, wherein the generating, according to the matched calling layer framework design mode, the entity classes and the calling method, the calling layer program of the smart contract client comprises the following steps:
defining and implementing conversion for the entity classes into tool classes of parameters of the smart contract: one-to-one conversion being directly carried out for basic types in the smart contract; for an array type and a variable length string type in the smart contract, splitting and converting a length of each fragment after splitting; and
encapsulating an API provided by the smart contract.

18. The non-transitory computer readable storage medium of claim 13, wherein the analyzing the interface of the smart contract comprises the following steps:
when the ABI of the smart contract is provided, converting an ABI text into an ABI analyzing object through a JSON conversion, so as to obtain information of all interfaces of the smart contract; and
when the source code of the smart contract is provided, syntactically analyzing a source code text of the smart contract to establish a syntax tree, so as to obtain the information of all interfaces of the smart contract.

19. The non-transitory computer readable storage medium of claim 13, wherein the generating, according to the interface analysis result, the entity classes corresponding to the incoming parameter and the return parameter of the interface of the smart contract comprises the following steps:
determining a name of a package where the entity classes are located according to a contract name, and determining an entity class name according to an interface name and a serial number of an interface definition;
converting types of the incoming parameter and the return parameter of the interface into field types of the entity classes;
determining names of fields of the entity classes according to naming information of the incoming parameter and the return parameter of the interface; and
generating a constructor, a Get method, a Set method, a To String method, an Equals method and a Hash Code method of the entity classes according to a POJO specification.

20. The non-transitory computer readable storage medium of claim 13, wherein the generating, according to the interface analysis result, the calling method corresponding to the interface of the smart contract comprises the following steps:
defining an interface of the call layer, wherein an interface name of the call layer is determined according to a contract name, a method in the interface of the call layer corresponds to the interface exposed in the smart contract, and a calling method name is determined according to the interface name and a serial number of an interface definition; an incoming parameter and a return parameter of the calling method are the corresponding entity classes; and
implementing an implementation class corresponding to the interface of the call layer, wherein an implementation class name is determined according to the contract name, and an method in the implementation class comprises the following steps:
converting the entity classes passed in as the incoming parameter of the calling method into corresponding smart contract parameters;
specifying the corresponding interface of the smart contract and passing in the smart contract parameters, and calling the corresponding interface through an API provided by the smart contract to obtain the return parameter of the smart contract; and
converting the return parameter of the smart contract into the corresponding entity class, which is returned by the calling method.
